(19) United States
(12) Patent Application Publication
(10) Pub. No.: US 2007/0030813 A1
(43) Pub. Date: Feb. 8, 2007

(54) Monitoring a problem condition in a communications protocol implementation

(75) Inventors: Andrew H. Arrowood, Raleigh, NC (US); Michael G. Fitzpatrick, Raleigh, NC (US); Constantinos Kassimis, Cary, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/199,301

(22) Filed: Aug. 8, 2005

(51) Int. Cl. H04L 1/00

(52) U.S. Cl. 370/241

(57) ABSTRACT

A solution for monitoring one or more problem conditions in a communications protocol implementation is provided. The communications protocol implementation includes an internal monitor thread that monitors one or more resources for problem condition(s). The internal monitor thread sets a problem flag based on a problem condition being present. A control process in the communications protocol implementation that controls a resource includes a problem monitor that resets the problem flag when the problem condition is cleared. To this extent, the problem monitor provides a check against the internal monitor thread. In this manner, the internal monitor thread and the problem monitor provide the communications protocol implementation with the ability to perform self-health monitoring.

### REFERENCE TO RELATED APPLICATION

The current application is related to co-owned and co-pending U.S. patent application No. ______ (Attorney Docket No. RSW920050118US1), filed on Aug. 8, 2005, and entitled “Monitoring A Problem Condition In A Communications System”, which is hereby incorporated herein by reference.

### BACKGROUND OF THE INVENTION

1. Technical Field

The invention relates generally to monitoring a problem condition, and more particularly, to a communications protocol implementation that performs self-health monitoring of one or more problem conditions.

2. Background Art

A systems network architecture (SNA) network provides high availability for mainframe systems, such as a zSeries eServer offered by International Business Machines Corp. of Armonk, N.Y. (IBM). Operating systems, such as IBM's z/OS exploit features of the SNA network to provide high performance for applications executing in a mainframe system. However, workloads processed by these mainframe systems are increasingly being driven by client requests flowing over an internet protocol (IP) network infrastructure. As a result, a lot of emphasis has been placed on ensuring that the z/OS IP network infrastructure delivers the same high availability attributes as those provided by the SNA network.

The use of a dynamic virtual IP address (DVIPA) is an important virtualization technology that assists in providing high availability z/OS solutions using IP networks in a cluster system (sysplex) environment. DVIPA provides an ability to separate the association of an IP address with a physical network adapter interface. To this extent, DVIPA can be viewed as a virtual destination that is not bound to a particular system/network interface, and therefore is not bound to any failure of any particular system/network interface. This results in a highly flexible configuration that provides the high availability on which many z/OS solutions depend.

DVIPA can be deployed using one of various configurations. Each configuration provides protection against a failure of a system, network interface and/or application. For example, in multiple application-instance DVIPA, a set of applications executing in the same z/OS image are represented by a DVIPA. This DVIPA allows clients to reach these applications over any network interface attached to the z/OS image and allows for automatic rerouting of traffic around a failure in a particular network interface. Additionally, should the primary system fail or enter a planned outage, the DVIPA can be automatically moved to another system in the sysplex. Further, a unique application-instance DVIPA can be associated with a particular application instance in the sysplex. In this case, the DVIPA can be dynamically moved to any system in the sysplex on which the application is executing. This DVIPA provides automatic recovery in scenarios where a particular application or system fails. In particular, a new instance of the application running on another system can trigger the DVIPA to be moved to the other system, allowing client requests to continue to be able to reach the application. Still further, a distributed DVIPA represents a cluster of one or more applications executing on various systems within a sysplex. In this case, new client transmission control protocol (TCP) connection requests can be load balanced across application instances active anywhere in the sysplex, thereby providing protection against the failure of any system, network interface and/or application in the sysplex, while also providing an ability to deploy a highly scalable solution within the sysplex.

As a result, DVIPA provides high availability TCP/IP communications to an application running in a sysplex environment even when a major component, such as a hardware system, an operating system, a TCP/IP protocol stack, a network adapter or an application, fails. In these situations, the failure is automatically detected and recovery action is automatically initiated, ensuring that client requests continue to be processed successfully. However, other problem conditions, apart from the failure of a major component, can prevent client requests from being processed successfully.

To this extent, a need exists for an improved communications protocol implementation that monitors one or more problem conditions.

### SUMMARY OF THE INVENTION

The invention provides a solution for monitoring one or more problem conditions in a communications protocol implementation. The communications protocol implementation includes an internal monitor thread that monitors one or more resources for problem condition(s). The internal monitor thread sets a problem flag based on a problem condition being present. A control process in the communications protocol implementation that controls a resource includes a problem monitor that resets the problem flag when the problem condition is cleared. To this extent, the problem monitor provides a check against the internal monitor thread. In one embodiment, the internal monitor thread is periodically executed, and only sets the problem flag after the problem condition has been present for a problem time period. Further, the internal monitor thread can take action in response to the problem condition only after the problem flag has been set for at least two consecutive executions. Additionally, the internal monitor thread can monitor the health of one or more external communication processes that are utilized by the communications protocol implementation using, for example, a heartbeat signal. In this manner, the internal monitor thread and the problem monitor provide the communications protocol implementation with the ability to perform self-health monitoring. Further, an external monitor can monitor critical functions of the communications protocol implementation to provide an external check on the health of the communications protocol implementation.

A first aspect of the invention provides a method of monitoring a set of problem conditions in a communications protocol implementation, the method comprising: controlling a resource exploited by the communications protocol implementation with a control process, wherein the control process includes a problem monitor for a first problem condition that is associated with the resource; and monitoring the resource for the first problem condition with an internal monitor thread, wherein the internal monitor thread sets a problem flag based on the first problem condition being present and the problem monitor resets the problem flag when the first problem condition is cleared.

A second aspect of the invention provides a system for monitoring a set of problem conditions in a communications protocol implementation, the system comprising: a set of control processes, wherein each control process controls a resource exploited by the communications protocol implementation, and wherein each control process includes a problem monitor for a first problem condition that is associated with the resource; and an internal monitor thread for monitoring the resource for the first problem condition, wherein the internal monitor thread sets a problem flag based on the first problem condition being present and the problem monitor resets the problem flag when the first problem condition is cleared.

A third aspect of the invention provides a communications protocol implementation comprising: a set of control processes, wherein each control process controls a resource exploited by a protocol, and wherein each control process includes a problem monitor for a first problem condition that is associated with the resource; and an internal monitor thread for monitoring the resource for the first problem condition, wherein the internal monitor thread sets a problem flag based on the first problem condition being present and the problem monitor resets the problem flag when the first problem condition is cleared.

A fourth aspect of the invention provides a system for processing messages in a communications protocol, the system comprising: a protocol implementation that includes: a set of control processes, wherein each control process controls a resource exploited by the protocol, and wherein each control process includes a problem monitor for a first problem condition that is associated with the resource; and an internal monitor thread for monitoring the resource for the first problem condition, wherein the internal monitor thread sets a problem flag based on the first problem condition being present and the problem monitor resets the problem flag when the first problem condition is cleared; an external monitor that monitors message processing by the protocol implementation, wherein the external monitor detects a second problem condition; and an external communication process utilized by the protocol implementation, wherein the internal monitor further monitors the external communication process.

A fifth aspect of the invention provides a computer-readable medium that includes computer program code to enable a computer infrastructure to process messages in a communications protocol, the computer-readable medium comprising computer program code for performing at least some of the method steps described herein.

A sixth aspect of the invention provides a method of generating a system for processing messages in a communications protocol, the method comprising: obtaining a computer infrastructure; and deploying means for performing at least some of the steps described herein to the computer infrastructure.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computing environment according to one embodiment of the invention.

FIG. 2 shows an illustrative data flow diagram that can be implemented by the TCP/IP stack of FIG. 1 according to one embodiment of the invention.

FIG. 3 shows illustrative process steps that can be implemented by the internal monitor thread of FIG. 1 according to one embodiment of the invention.

FIG. 4 shows illustrative process steps that can be implemented by the problem monitor of FIG. 1 according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a solution for monitoring one or more problem conditions in a communications protocol implementation. The communications protocol implementation includes an internal monitor thread that monitors one or more resources for problem condition(s). The internal monitor thread sets a problem flag based on a problem condition being present. A control process in the communications protocol implementation that controls a resource includes a problem monitor that resets the problem flag when the problem condition is cleared. To this extent, the problem monitor provides a check against the internal monitor thread. In one embodiment, the internal monitor thread is periodically executed, and only sets the problem flag after the problem condition has been present for a problem time period. Further, the internal monitor thread can take action in response to the problem condition only after the problem flag has been set for at least two consecutive executions. Additionally, the internal monitor thread can monitor the health of one or more external communication processes that are utilized by the communications protocol implementation using, for example, a heartbeat signal. In this manner, the internal monitor thread and the problem monitor provide the communications protocol implementation with the ability to perform self-health monitoring. Further, an external monitor can monitor critical functions of the communications protocol implementation to provide an external check on the health of the communications protocol implementation.

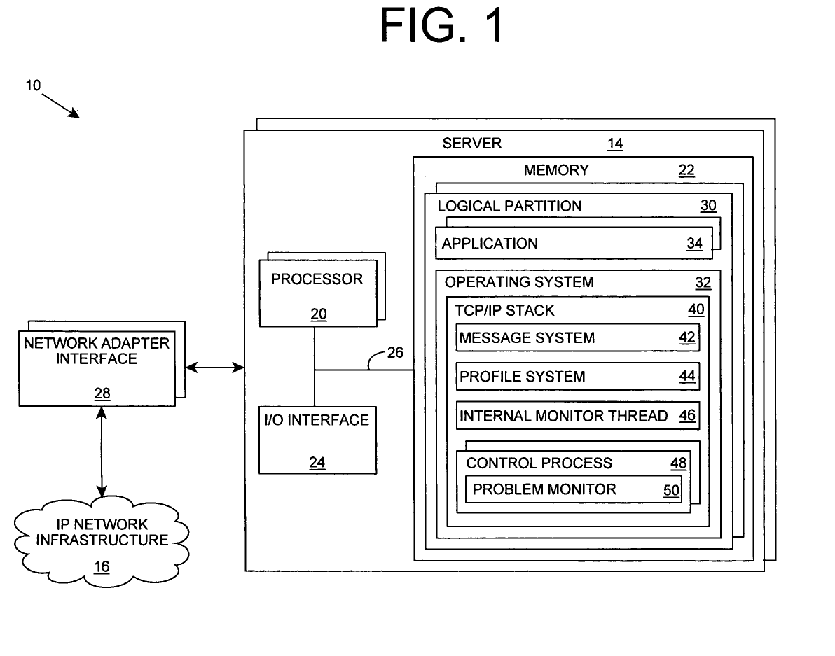

Turning to the drawings, FIG. 1 shows an illustrative computing environment 10 according to one embodiment of the invention. In particular, environment 10 includes a set (one or more) of servers 14 that communicate over a network, such as an internet protocol (IP) network infrastructure 16, via a set of network adapter interfaces 28. Server 14 is shown including one or more processors 20, a memory 22, an input/output (I/O) interface 24 and a bus 26. As is known in the art, memory 22 is capable of including a plurality of logical partitions 30, each of which includes an operating system 32, which can be running one or more applications 34. In general, processor(s) 20 execute computer program code, such as application 34, that is stored in memory 22. While executing computer program code, processor 20 can read and/or write data to/from memory 22 and/or I/O interface 24. Bus 26 provides a communications link between each of the components in server 14. I/O interface 24 can comprise any device that enables a user (not shown) to interact with server 14 and/or enables server 14 to communicate with one or more other computing devices, such as network adapter interface 28, with or without the use of one or more additional components.

Communications between application 34 and one or more nodes (e.g., computing devices, applications, etc.) connected to IP network infrastructure 16 use a particular communications protocol. For example, common communication protocols comprise the transmission control protocol (TCP), and the internet protocol (IP), which together are commonly used to enable communication over public and/or private networks. IP network infrastructure 16 can comprise any combination of one or more types of networks (e.g., the Internet, a wide area network, a local area network, a virtual private network, etc.). Further, communication over IP network infrastructure 16 can utilize any combination of various wired/wireless transmission techniques and/or communication links. While shown and discussed herein with reference to the TCP/IP protocol as an illustrative embodiment, it is understood that the invention is not limited to TCP/IP protocol, and any type of communications protocol can be used.

The communications protocol defines how messages are created and subsequently processed by the sender and receiver. For example, the communications protocol defines a format for messages, specifies how endpoints are identified, specifies how data is stored, and the like. In order to process messages in a particular communications protocol, an operating system 32 generally includes an implementation of the communications protocol. When the communications protocol is implemented using a hierarchy of software layers, the communications protocol implementation is typically referred to as a “protocol stack”. To this extent, operating system 32 is shown including a TCP/IP stack 40 that provides support for sending and receiving messages in the TCP and IP protocols. Additionally, operating system 32 can include one or more additional systems that can be utilized and shared by multiple communications protocol implementations while processing messages.

TCP/IP stack 40 enables operating system 32 to process messages in the TCP and IP protocols by performing some or all of the process steps of the invention. To this extent, TCP/IP stack 40 is shown including a message system 42, a profile system 44, an internal monitor thread 46 and a set (one or more) of control processes 48, each of which includes a problem monitor 50. Operation of each of these systems is discussed further below. However, it is understood that some of the various systems shown in FIG. 1 can be implemented independently, combined, and/or stored in memory for one or more separate computing devices that are included in environment 10. Further, it is understood that some of the systems and/or functionality may not be implemented, or additional systems and/or functionality may be included as part of environment 10.

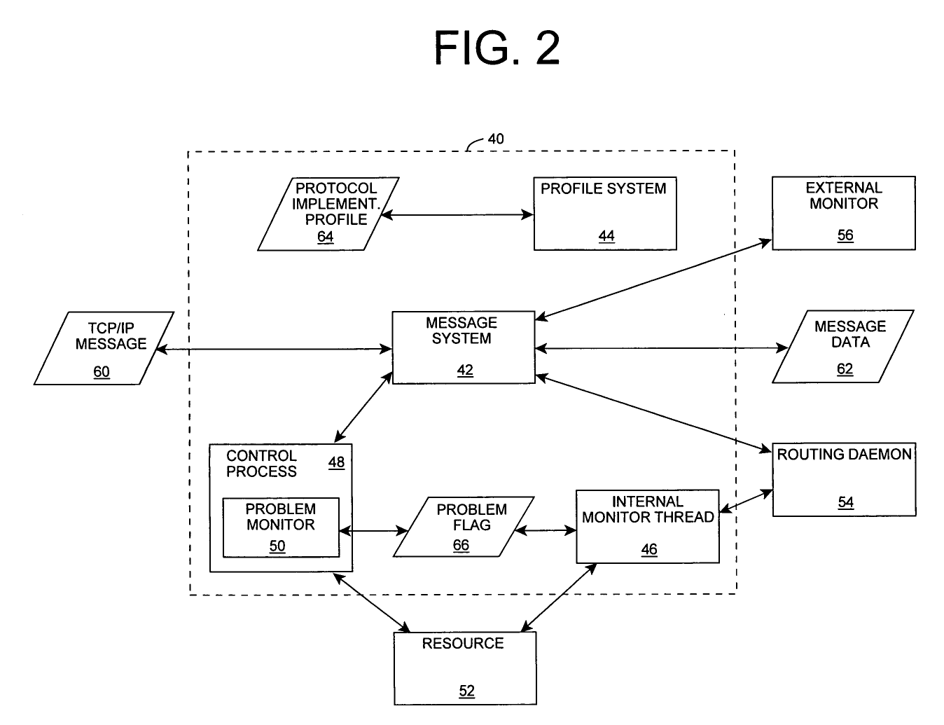

Regardless, the invention provides a communications protocol implementation, such as TCP/IP stack 40, that monitors a set (one or more) of problem conditions in the communications protocol implementation. FIG. 2 shows an illustrative data flow diagram that can be implemented by TCP/IP stack 40 according to one embodiment of the invention. In particular, message system 42 can receive a TCP/IP message 60, process the TCP/IP message 60, and forward message data 62 and/or TCP/IP message 60 to another node (e.g., application 34 of FIG. 1) for further processing. Similarly, message system 42 can receive message data 62, generate one or more TCP/IP messages 60 based on message data 62, and forward TCP/IP message(s) 60 to another node (e.g., network adapter interface 28 of FIG. 1) for further processing.

While processing TCP/IP message 60 and/or message data 62, message system 42 can exploit one or more resources 52 on server 14 (FIG. 1). Resource 52 can comprise any type of computing resource, and is typically shared between multiple systems (e.g., TCP/IP stacks 40, logical partitions 30 (FIG. 1), etc.). For example, resource 52 can comprise some or all of an address space in memory 22 (FIG. 1) that is required to implement certain processing functions. Further, resource 52 can comprise a communications route, such as one required to implement DVIPA functionality, to one or more additional servers 14 in a server cluster.

When exploiting a resource 52, TCP/IP stack 40 can incur one or more problem conditions. Using IBM's SNA sysplex environment and TCP/IP communications in z/OS operating system as an illustrative environment, a problem condition can arise with the availability of the virtual telecommunications access method (VTAM) address space. The VTAM address space is exploited by TCP/IP stack 40 when performing various processing for a z/OS communication server network attachment. When the VTAM address space is not available to TCP/IP stack 40 for a prolonged period, TCP/IP processing, including any DVIPA operations, will be adversely impacted. Additionally, one or more problem conditions, such as a critical shortage, can occur with other storage resources including, for example, communication storage manager (CSM) storage, extended common storage area (ECSA), TCP/IP private storage, etc.

Similarly, TCP/IP stack 40 exploits a cross-system coupling facility (XCF) route when communicating with other systems in the sysplex. When no XCF route is available, server 14 (FIG. 1) is isolated from the remaining systems in the sysplex. Such a problem condition prevents TCP/IP stack 40 from being able to forward any DVIPA communications to the other systems. Additionally, TCP/IP stack 40 can exploit a dynamic IP routing protocol daemon 54, such as OMPROUTE, to implement DVIPA functionality. When this daemon is not working, TCP/IP stack 40 may not be able to properly implement some or all of the DVIPA functionality. It is understood that these resources are only illustrative of numerous types of resources 52 that can be exploited by TCP/IP stack 40.

In any event, TCP/IP stack 40 can include a set (one or more) of control processes 48, each of which controls a unique resource 52 exploited by message system 42. Control process 48 can manage obtaining resource 52, exploiting resource 52 (e.g., reading/writing data from/to resource 52), relinquishing resource 52, and the like, in a known manner. Additionally, TCP/IP stack 40 can include an internal monitor thread 46 that monitors resource(s) 52 for one or more problem conditions. Internal monitor thread 46 can execute periodically, and monitor several resources 52 and/or problem conditions for each resource 52. Internal monitor thread 46 can set a problem flag 66 that is unique to each problem condition and resource 52 combination based on the problem condition being present.

Additionally, control process 48 can include a problem monitor 50 for each monitored problem condition that corresponds to the resource 52 that is controlled by control process 48. When problem monitor 50 detects that the corresponding problem condition has been cleared, problem monitor 50 can reset the problem flag 66 for the problem condition and resource 52 combination. Problem flag 66 can be implemented in any known manner. For example, problem flag 66 can comprise a designated shared memory location/portion of a memory location (e.g., a bit). In this case, problem monitor 50 and internal monitor thread 46 can read and/or write to problem flag 66 using uninterruptible operations, semaphores, or the like.

In one embodiment, prior to initiating a recovery action, internal monitor thread 46 can first determine whether the problem condition has persisted for at least a predefined problem time period. To this extent, internal monitor thread 46 can further track a time period that the problem condition has persisted using any solution. The problem time period can be fixed or can be configured by a user/system. In the latter case, the problem time period can be defined in a protocol implementation profile 64. For example, TCP/IP stack 40 can include a profile system 44 for managing protocol implementation profile 64. Profile system 44 can generate a user interface or the like that enables a user to define the one or more profile settings (e.g., the problem time period), can read and/or process profile setting data, can receive and/or generate profile setting data, can write profile setting data to protocol implementation profile 64, and/or the like.

In any event, profile system 44 can obtain protocol implementation profile 64 and provide profile setting data to other systems in TCP/IP stack 40. To this extent, profile system 44 can obtain the problem time period from protocol implementation profile 64 and provide it to internal monitor thread 46. In one embodiment, internal monitor thread 46 is periodically executed based on the problem time period. For example, internal monitor thread 46 could be executed four times during the problem time period (e.g., every fifteen seconds when the problem time period is set to sixty seconds). When internal monitor thread 46 is monitoring multiple problem conditions, the same problem time period can be used for all of the problem conditions. Alternatively, different problem time periods could be defined for different problem conditions. In the latter case, the frequency with which internal monitor thread 46 is executed can be determined based on the shortest problem time period. Alternatively, multiple internal monitor threads 46 can be used, each of which monitors a unique set of related problem conditions (e.g., all problem conditions having the same problem time period).

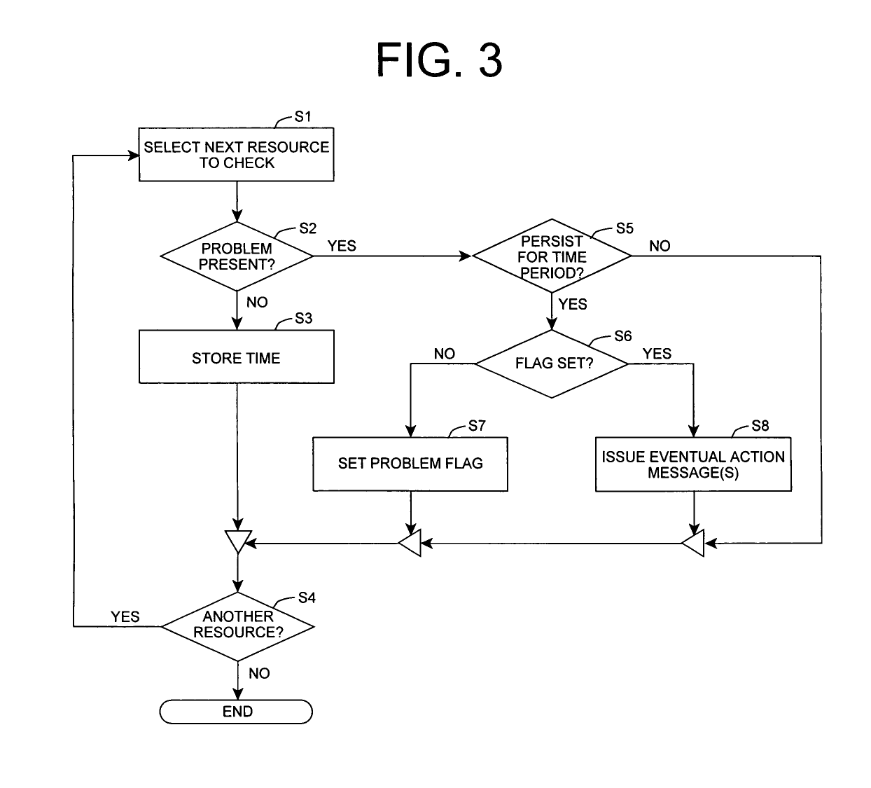

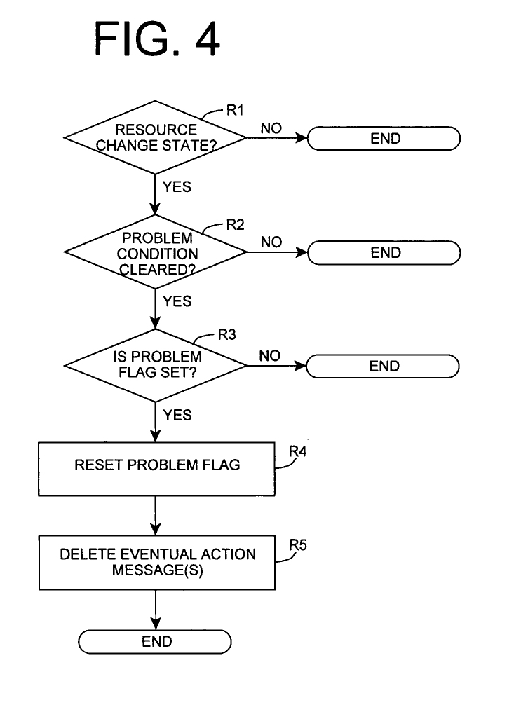

FIGS. 3 and 4 show illustrative process steps that can be implemented by internal monitor thread 46 (FIG. 2) and problem monitor 50 (FIG. 2), respectively. Referring to FIGS. 2 and 3, in step S1, internal monitor thread 46 selects a resource 52 to check for the presence of one or more problem conditions. In step S2, internal monitor thread 46 determines if the problem condition is present. If not, then in step S3, internal monitor thread 46 can store the current time. Subsequently, in step S4, internal monitor thread 46 determines if there is another resource 52, and if so, flow returns to step S1 for the next resource 52. Otherwise, internal monitor thread 46 ends. As a result, internal monitor thread 46 only processes each resource 52 once during each execution, and TCP/IP stack 40 can periodically execute internal monitor thread 46, e.g., once every fifteen seconds.

When, in step S2, internal monitor thread 46 determines that the problem condition is present, then in step S5, internal monitor thread 46 determines whether the problem condition has persisted for the problem time period. For example, internal monitor thread 46 can subtract the last time stored in step S3 from the current time to determine if the difference exceeds the problem time period. If the problem condition has not persisted for at least the problem time period, then flow continues to step S4. When the problem condition has persisted for the problem time period, then in step S6, internal monitor thread 46 can determine if problem flag 66 has been set. When problem flag 66 is not set, then in step S7, internal monitor thread 46 sets problem flag 66 and flow continues to step S4.

Turning to FIGS. 2 and 4, in step R1, problem monitor 50 can determine whether a resource condition has changed state (e.g., an availability of resource 52 changed). If so, in step R2, problem monitor 50 can determine whether the corresponding problem condition for resource 52 is cleared (e.g., resource 52 is now available). If so, in step R3, problem monitor 50 can determine whether problem flag 66 for the problem condition is set. If so, in step R4, problem monitor 50 can reset problem flag 66.

Since internal monitor thread 46 only processes each resource 52 once during each execution, problem flag 66 will be set for at least the time period between consecutive executions of internal monitor thread 46 before any action is taken. This enables problem monitor 50 to act as a check against the false identification of a problem condition by internal monitor thread 46, e.g., when a problem condition occurs for only a brief period of time. Returning to FIGS. 2 and 3, when internal monitor thread 46 determines that the problem condition is present (step S2), the problem has persisted for the problem time period (step S5) and problem flag 66 is set (step S6), the problem condition has persisted for the problem time period and for at least one additional execution of internal monitor thread 46, during which problem monitor 50 could have reset problem flag 66. Consequently, internal monitor thread 46 can take action in response to the problem condition.

To this extent, in step S8, internal monitor thread 46 can issue one or more eventual action messages. Each eventual action message can include data on the particular problem condition that was detected, and can be sent to, for example, a console for the sysplex, another system executing within operating system 32 (FIG. 1), or the like. Subsequently, a user and/or another system can determine what, if any, further action should be taken in response to the problem condition. Returning to FIGS. 2 and 4, when problem monitor 50 detects that problem flag 66 is set in step R3, in step R5, it can delete any eventual action messages that were issued by internal monitor thread 46. In this manner, a user and/or another system can be made aware that the problem condition has been cleared, and no additional action will be taken in response to the cleared problem condition.

It is understood that the method steps of FIGS. 3 and 4 are only illustrative and various alternatives can be implemented. For example, internal monitor thread 46 could determine if problem flag 66 is set before it determines if the problem condition has persisted for the problem time period. Additionally, internal monitor thread 46 could require that problem flag 55 be set for the problem time period before taking any action. In this case, each time internal monitor thread 46 sets problem flag 66, it can store a time that problem flag 66 was set. Subsequently, when internal monitor thread 46 determines that problem flag 66 was already set, it can subtract the stored time from the current time to determine the time period that problem flag 66 has been set. The time period can be compared to the problem time period to determine whether the problem time period has expired (e.g., the time period is greater than or equal to the problem time period).

Returning to FIG. 2, TCP/IP stack 40 can comprise a portion of a communications system for server 14 (FIG. 1). To this extent, additional problem conditions in TCP/IP stack 40 can be monitored using an external monitor 56. For example, external monitor 56 can detect a failure of a function in message system 42. When the failure (e.g., an abend) occurs in a critical code path, external monitor 56 can detect the problem condition. Similarly, external monitor 56 can monitor a responsiveness of one or more critical functions, such as a TCP/IP sysplex DVIPA function, by periodically checking that these functions are active, and are not suspended waiting for a key resource, such as an internal TCP/IP lock. When external monitor 56 detects a problem condition, it can take action, such as issue one or more eventual action message(s). In this manner, external monitor 56 provides an independent monitoring function that can detect problems even in a scenario in which internal monitor thread 46 is not working properly.

In addition to monitoring problems, such as availability, of resources 52, internal monitor thread 46 can monitor one or more external communication processes that are utilized by TCP/IP stack 40 during message processing. In this case, internal monitor thread 46 can determine a health of the external communication process(es). For example, message system 42 can use a routing daemon 54 when implementing certain DVIPA functionality. Routing daemon 54 can periodically send a “heartbeat” signal that is received by internal monitor thread 46. When internal monitor thread 46 does not receive the heartbeat signal for a certain period of time (e.g., the problem time period plus one additional execution), then internal monitor thread 46 can identify it as a problem condition and respond accordingly (e.g., issue eventual action message(s)). To this extent, internal monitor thread 46 can set a problem flag 66 for routing daemon 54 as discussed herein. Further, while not shown, TCP/IP stack 40 can include a control process 48 that controls the external communication process, such as routing daemon 54 and can reset the problem flag 66 when the problem condition is cleared (e.g., the heartbeat signal is received).

While shown and described herein as a method and system for monitoring a set of problem conditions in a communications protocol implementation, it is understood that the invention further provides various alternative embodiments. For example, in one embodiment, the invention provides a computer-readable medium that includes computer program code to enable a computer infrastructure to monitor a set of problem conditions in a communications protocol implementation. To this extent, the computer-readable medium includes program code, such as TCP/IP stack 40 (FIG. 1), that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) (e.g., a fixed disk, a read-only memory, a random access memory, a cache memory, etc.), and/or as a data signal traveling over a network (e.g., during a wired/wireless electronic distribution of the program code).

In still another embodiment, the invention provides a method of generating a system for monitoring a set of problem conditions in a communications protocol implementation. In this case, a computer infrastructure, such as environment 10 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as server 14, from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of monitoring a set of problem conditions in a communications protocol implementation, the method comprising:
controlling a resource exploited by the communications protocol implementation with a control process, wherein the control process includes a problem monitor for a first problem condition that is associated with the resource; and
monitoring the resource for the first problem condition with an internal monitor thread, wherein the internal monitor thread sets a problem flag based on the first problem condition being present and the problem monitor resets the problem flag when the first problem condition is cleared.

2. The method of claim 1, further comprising issuing an eventual action message in response to the first problem condition.

3. The method of claim 2, further comprising deleting the eventual action message when the first problem condition is cleared.

4. The method of claim 1, further comprising monitoring message processing for the protocol using an external monitor, wherein the external monitor detects a second problem condition.

5. The method of claim 1, further comprising monitoring an external communication process utilized during message processing for the protocol with the internal monitor thread.

6. The method of claim 1, further comprising tracking a time period that the first problem condition has persisted.

7. The method of claim 6, further comprising:
obtaining a problem time period;
determining whether the first problem condition has persisted for at least the problem time period; and
seting the problem flag when the first problem condition has persisted for at least the problem time period.

8. The method of claim 7, further comprising obtaining a protocol implementation profile, wherein the protocol implementation profile includes the problem time period.

9. A system for monitoring a set of problem conditions in a communications protocol implementation, the system comprising:
a set of control processes, wherein each control process controls a resource exploited by the communications protocol implementation, and wherein each control process includes a problem monitor for a first problem condition that is associated with the resource; and
an internal monitor thread for monitoring the resource for the first problem condition, wherein the internal monitor thread sets a problem flag based on the first problem condition being present and the problem monitor resets the problem flag when the first problem condition is cleared.

10. The system of claim 9, wherein the internal monitor thread issues an eventual action message in response to the problem flag being set for at least two consecutive executions of the internal monitor thread.

11. The system of claim 9, further comprising a profile system for obtaining a protocol implementation profile, wherein the protocol implementation profile includes a problem time period for which the first problem condition must persist before any action is taken.

12. The system of claim 9, further comprising an external monitor that monitors message processing for the protocol, wherein the external monitor detects a second problem condition.

13. The system of claim 9, further comprising an external communication process utilized during message processing for the protocol, wherein the internal monitor further monitors the external communication process.

14. A communications protocol implementation comprising:
a set of control processes, wherein each control process controls a resource exploited by a protocol, and wherein each control process includes a problem monitor for a first problem condition that is associated with the resource; and
an internal monitor thread for monitoring the resource for the first problem condition, wherein the internal monitor thread sets a problem flag based on the first problem condition being present and the problem monitor resets the problem flag when the first problem condition is cleared.

15. The communications protocol implementation of claim 14, further comprising a profile system for obtaining a protocol implementation profile, wherein the protocol implementation profile includes a problem time period for which the first problem condition must persist before any action is taken.

16. The communications protocol implementation of claim 14, wherein the internal monitor further monitors an external communication process utilized during message processing for the protocol.

17. The communications protocol implementation of claim 14, wherein the protocol comprises the transmission control protocol/internet protocol (TCP/IP).

18. A system for processing messages in a communications protocol, the system comprising:
a protocol implementation that includes:
a set of control processes, wherein each control process controls a resource exploited by the protocol, and wherein each control process includes a problem monitor for a first problem condition that is associated with the resource; and
an internal monitor thread for monitoring the resource for the first problem condition, wherein the internal monitor thread sets a problem flag based on the first problem condition being present and the problem monitor resets the problem flag when the first problem condition is cleared;
an external monitor that monitors message processing by the protocol implementation, wherein the external monitor detects a second problem condition; and
an external communication process utilized by the protocol implementation, wherein the internal monitor further monitors the external communication process.

19. The system of claim 18, wherein the protocol implementation further includes a profile system for obtaining a protocol implementation profile, wherein the protocol implementation profile includes a problem time period for which the first problem condition must persist before any action is taken.

20. The system of claim 18, wherein the internal monitor thread issues an eventual action message in response to the problem flag being set for at least two consecutive executions of the internal monitor thread.
